(19) United States
(12) Patent Application Publication
(10) Pub. No.: US 2004/0095648 A1
(43) Pub. Date: May 20, 2004

(54) Lenticular sleeves

(76) Inventors: Duncan A. McCannel, Eagan, MN (US); John Tomczyk, Shoreview, MN (US)

Correspondence Address: Peter Forrest, Gray Plant Mooty Mooty & Bennett, P O Box 2906, Minneapolis, MN, 55402-0906, US

(21) Appl. No.: 10/472,054

(22) PCT Filed: Feb. 14, 2003
(86) PCT No.: PCT/US03/04693

(51) Int. Cl. G02B 27/10; B29D 11/00

(52) U.S. Cl. 359/619; 264/1.7

(57) ABSTRACT

Flat lenticular blanks are configured into (preferably but not necessarily tapered) self-supporting sleeves, by joining opposite sides together at a seam or other interface. The sleeves may be used in applications such as lenticular inserts for injection molded containers, attachments to existing objects; components of lenticular containers manufactured using modified paper cup technology, or glued onto existing paper or plastic cups or containers.

### CROSS REFERENCE TO RELATED APPLICATIONS

This application claims the benefit of each of the provisional applications numbered 60/357,474 (filed Feb. 15, 2002) and 60/402,296 (filed Aug. 8, 2002). It is related to the inventions disclosed and claimed in commonly assigned pending unpublished application Ser. No. 09/566,363 filed May 5, 2000 and Ser. No. 10/349,563 filed Jan. 22, 2003, both of which claim priority from provisional application 60/182,490 filed Feb. 15, 2000.

### TECHNICAL FIELD

The technology described below includes systems and methods for producing sleeve-like lenticular objects, or “lenticular sleeves,” and also the lenticular sleeves themselves. Lenticular sleeves are particularly useful in the manufacture of containers displaying lenticular images, as standalone containers bearing a lenticular image, and as standalone objects which may be added at any point to another object (for example, the point of sale to an end user).

### BRIEF DESCRIPTION OF THE DRAWINGS

The accompanying drawings are schematic, and therefore may not exactly match the appearance of a commercial embodiment of the technology described by the text and claims below.

FIG. 1 is a schematic diagram of an embodiment of a lenticular blank according to the invention.

FIG. 2 is a cross-section taken along the line 2-2 of FIG. 1.

FIG. 3 is a partial side view of the lenticular blank of FIGS. 1 and 2 during a preferred process of forming a lenticular sleeve.

FIG. 4 is a schematic diagram of another embodiment of a lenticular blank according to the invention.

FIG. 5 is a cross-section taken along the line 5-5 of FIG. 4.

FIG. 6 is a perspective view of the lenticular sleeve formed from the lenticular blank of FIGS. 1 and 2 according to the process of FIG. 3.

FIG. 7 is a cross-section of another embodiment of the invention.

### DETAILED DESCRIPTION

In addition to the description below, the following are incorporated in their entireties as part of this disclosure: U.S. Pat. Nos. 2,942,530; 5,525,383; 5,752,907; 6,158,612; 6,182,855; and 6,490,063; Published US Patent Application US 2002/0114080; and the following International Applications Published under the Patent Cooperation Treaty: WO 01/96079A2 and 02/051611A1. The invention concerns lenticular sleeves, formed from preferred materials and/or in a preferred process, that are suitable for uses disclosed in one or more of these documents, as well as the commonly owned related applications noted above.

For convenience only, this description will on occasion refer to a cup or similar single-ended volume container, but other containers within the full scope of the invention include (but are not limited to) bottles and other similar packages for other materials.

One of ordinary skill in this art will appreciate that the lenticular materials described here may also serve as standalone containers, e.g., cups, bottles, other containers, and packages in general. This may require suitable modifications to this disclosure that are within their skill. Similarly, lenticular materials created according to the principles of the invention may also serve as separate objects that are intended to be added to other objects.

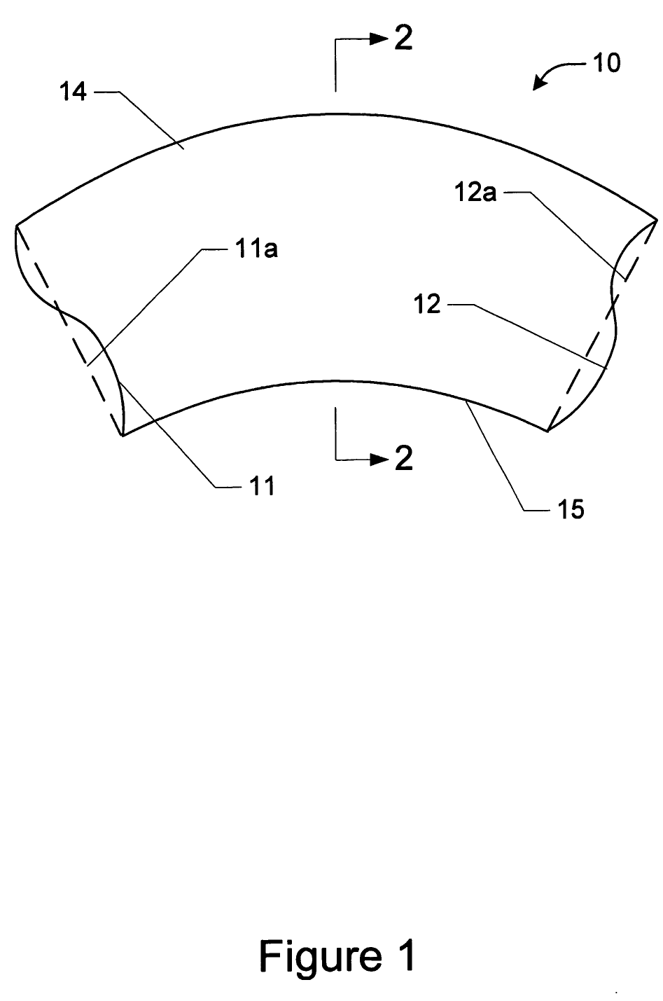

FIG. 1 is a front view of a lenticular blank 10 having opposed sides 11 and 12 that are illustrated as arbitrarily curved but are preferred to be straight as indicated by dashed lines 11a and 12a. Any shape that permits mating sides to fit together to form a closed surface sleeve with a continuous seam, as will be discussed below, is within the scope of the invention. For example, sinusoidal and zig-zag seams are possible. It is preferred but not required that the sides mate with each other as illustrated, however, especially in the case of overlapping seams formed as described below, it may be advantageous for each side to have a different shape, and all such shapes are considered to be within the scope of the invention.

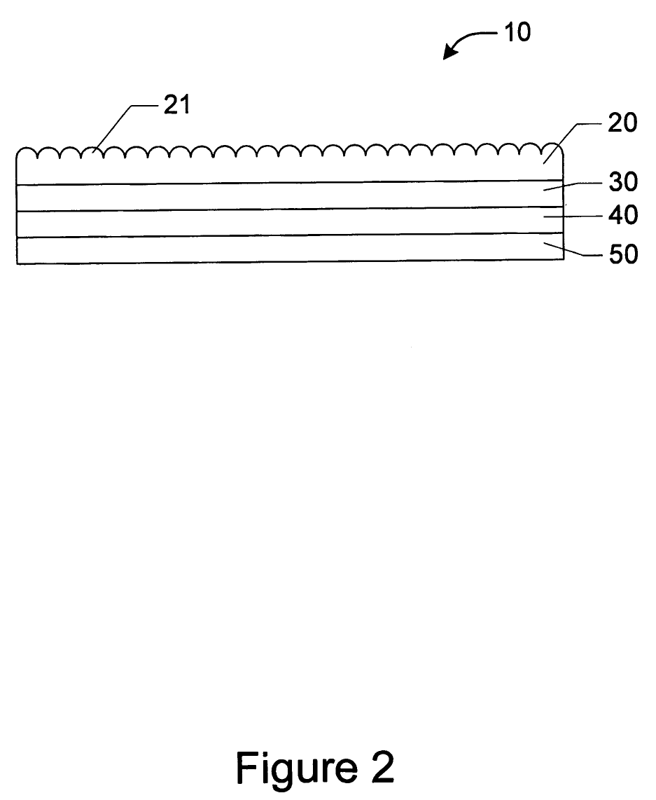

FIG. 2 is a cross section of lenticular blank 10, illustrating various layers that are preferably formed into an integral laminate according to known principles of printing, laminating, and other similar forms of assembly. Lenticular layer 10 comprises an array of lenticules 21 on its outer (in the Figure, its upper) or front face; the size and number of lenticules 21 is coordinated with the size and number of interlaced striped images that form image layer 30. Cylindrical lenticules are illustrated and preferred, but other shapes are within the scope of the invention. As is well known, printing or otherwise forming such an interlaced image layer 30 onto the inner (lower) or back face of lenticular material 10 permits the viewer, who is viewing from the upper side of the figure (i.e., they are viewing the outer or front face), to perceive images depending on the angle at which image layer 30 is viewed through lenticules 21. As is well known in the art and applicable for this entire disclosure, the images perceived in this manner may be three-dimensional images, alternating two or three dimensional images, and other known types of images.

One or more optional layers may be included in the integral laminate 10. For example, optional backing layer 40 and optional protection layer 50 may be added to the integral construction of lenticular blank 10 depending on the end use application, as described below. If used, the outer side of backing layer 40 is immediately adjacent (if not in actual contact with) the inner side of image layer 30; similarly, the outer side of protection layer 50 is immediately adjacent (if not in actual contact with) the inner side of backing layer 40. A substrate material (not shown), such as the injection molded plastic to be described below, may be immediately adjacent (if not in actual contact with) the inner side of the lowest layer of the laminate, whichever type of layer that may be.

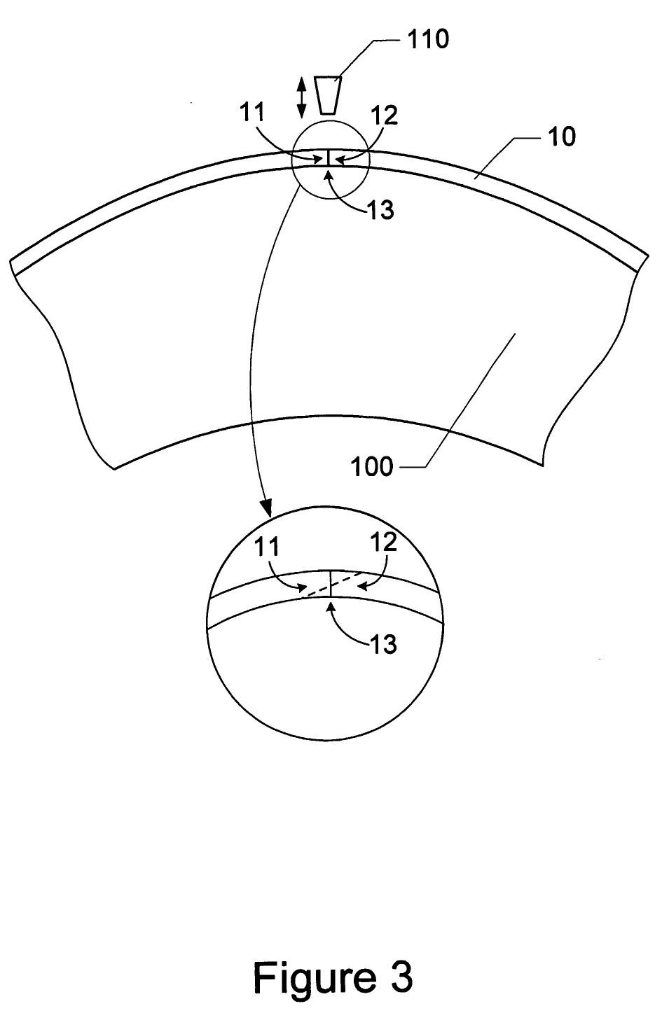

FIG. 3 illustrates the formation of a closed-surface sleeve from lenticular blank 10 by use of a known (but for the modifications described here) machine commonly used to manufacture paper cups. In this process, lenticular blank 10 is placed on mandrel 100 and ends 11 and 12 are brought together, all in a conventional manner. Seam 13 is formed between ends 11 and 12 by bonding applicator 110. The bonding applicator can employ any one or more of heat, pressure, applied or activated adhesive, or other similar known means for joining the particular materials employed. Also, as is known in the art of such machinery, supplemental heat can be applied if desired, from either below or above lenticular blank 10 as it is wound around mandrel 100. This ensures that the region in the vicinity of end 11 or 12 (or both) is sufficiently heated or otherwise prepared for formation of seam 13.

Details of the wrapping process and equipment are well known in the art. Examples include U.S. Pat. No. 2,942,530 (for generally cylindrical or conical containers); U.S. Pat. No. 4,349,345 (for non-cylindrical containers); U.S. Pat. No. 4,490,130 (heating of the blank); U.S. Pat. Nos. 5,569,143; and 5,752,907 (mechanical release of the formed sleeve from the mandrel). The entire contents of each of these documents is incorporated by reference.

While FIG. 3 illustrates the preferred embodiment in which ends 11 and 12 are brought together without overlap (and thus without increasing the net cross-sectional thickness of lenticular blank 10) in the vicinity of seam 13. This is for illustrative purposes only, as the invention includes embodiments in which such overlap is formed. For example, the invention includes embodiments in which ends 11 and 12 are cut at an angle, i.e., skived, as indicated in the alternative embodiment illustrated by the dashed lines in the magnified portion of the figure. The exact value of the skive angle is not critical to the invention.

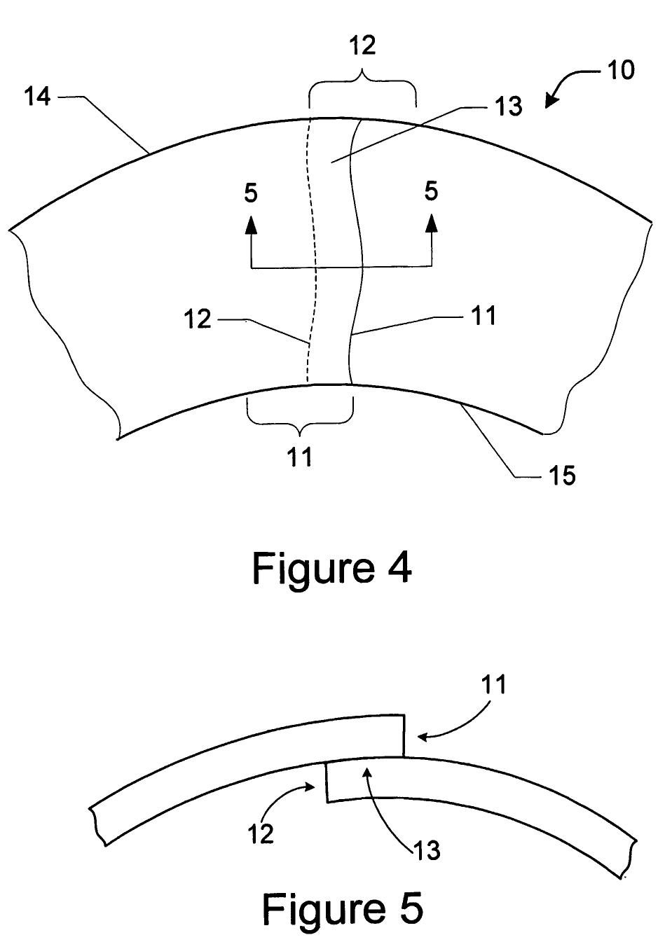

Also, as is well understood in the art, a minor amount of overlap may be required or desirable depending on the materials, techniques for joining ends 11 and 12 employed, intended end use, and other factors. Thus, in another example, FIGS. 4 and 5 illustrate an alternative embodiment with an overlapping seam 13. It may be desirable to for either or both of ends 11 and 12 to be angled or skived in this embodiment also, so that the outermost surface is smoother than illustrated in these schematic figures.

Therefore, it should be understood that discussion of ends 11 and 12 refers not just to the most extreme locations forming the opposite sides of lenticular blank 10 when lying flat, but also, if context so dictates or permits, to the general regions of the opposed portions of lenticular blank 10 which become the region in which seam 13 is formed.

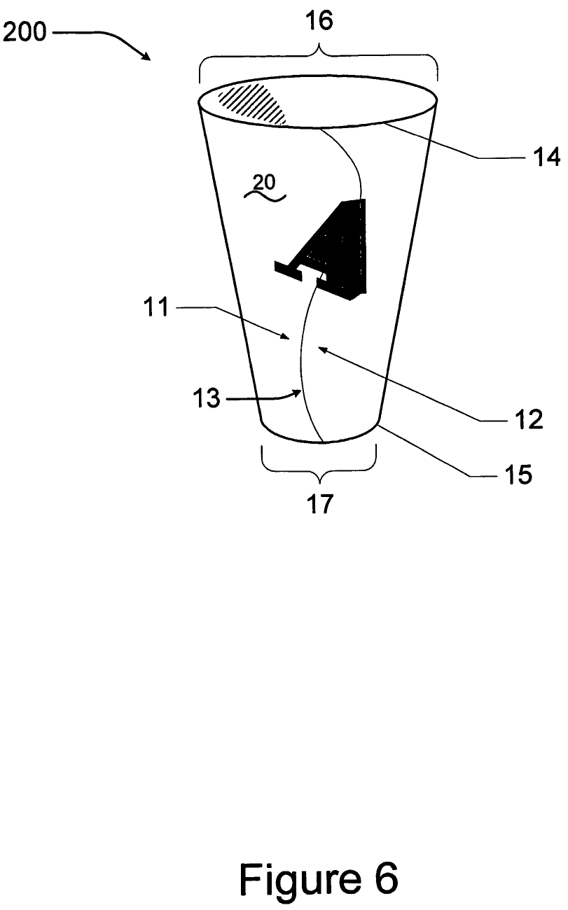

FIG. 6 is a perspective view of a closed-surface lenticular sleeve 200 formed in the process illustrated by FIG. 3 and afterward removed from mandrel 100. In the preferred embodiment of FIG. 1, in which lenticular blank 10 has upper and lower curved surfaces 14 and 15, the closed-surface lenticular sleeve 200 is a portion, or frustrum, of a hollow tapered sleeve or hollow inverted cone. Lenticular material 20 faces outward, i.e., the image (as schematically illustrated, a three-dimensional letter “A”) appears on the outer surface of sleeve 200.

The sleeve of FIG. 6 may also be characterized as self-supporting or free-standing. That is, because seam 13 integrally joins ends 11 and 12 and therefore prevents lenticular sleeve 200 from unfurling to resume its flat shape after being removed from the manufacturing equipment, lenticular sleeve 200 can be said to be self-supporting in the shape it ultimately assumes (e.g., a frustrum of a cone, a cylinder, and so on). In the particular shape illustrated in FIG. 6, the circular cross-sectional shape of lenticular sleeve 200 ensures that the upper and lower ends 16 and 17, respectively, are closed plane figures (in this specific case, circles) as opposed to merely linear edges in the case of upper and lower edges 14 and 15, respectively. In the most general case, creation of a sleeve, creates sufficient locations on at least one end of the sleeve to allow the sleeve to be free-standing on a suitable surface. Either of these characteristics, the self-supporting nature, or the free-standing nature, distinguish these embodiments of the invention from other lenticular blanks that have been previously employed to incorporate lenticular images into containers and similar objects.

Sleeves formed according to the general process described above may be products for use in at least four major applications: (1) As lenticular inserts for injection molded cups; (2) As lenticular tapered sleeves to be attached to existing paper or plastic cups; (3) as a lenticular tapered sleeve that may be glued onto existing paper or plastic cups or containers; or (4) as a component of lenticular cups made using modified existing paper cup technology, i.e., by adding a bottom to either of the open ends of the sleeve illustrated in FIG. 6 (typically but not necessarily the smaller diameter end). Each of these is described in the following examples, which are illustrative only. The scope of possible uses of the invention is not limited by these examples.

### EXAMPLE ONE

A tapered lenticular sleeve that can be used as an insert in the injection molding of cups is constructed generally as described above.

A suitable lenticular sheet has a thickness between 0.005 and 0.025 inch (0.0127 mm and 0.0635 mm), measured from the typically flat back side of the material (i.e., the lower side as illustrated in FIG. 2) to the maximum height of any lenticules on the front side of the material (the upper side in FIG. 2). Other known lenticular materials, such as those in which each the lenticules have arc angles greater than about 90 degrees and widths less than about 0.0067 inches (0.17 millimeters), as disclosed in U.S. Pat. No. 6,424,467 (the entire contents of which are incorporated by reference) are also suitable.

Suitable compounds for the material include amorphous polyester terephthalate (APET), glycol-modified polyethylene terephthalate (PETG), polyvinylchloride (PVC), polycarbonate, polypropylene, and other materials known to have similar optical and materials properties for this application. The finish of the material is gloss on the front, or outer, side having the lenticular lenses, and may be either gloss or matte on the back, or inner, side on which the image is formed. The preferred range of lens pitch is between sixty and four hundred lenticules per inch (between 23.6 lenticules per centimeter and 157.5 lenticules per centimeter, respectively).

An interlaced image, comprising two or more sets of images prior to interlacing, is formed on the back side of the lenticular sheet. The preferred image formation process uses inks that are curable with ultraviolet (UV) light, but other, conventional inks may be used.

An optional backing material is preferably laminated over the image. It has a thickness between 0.0055 and 0.005 inch (0.14 and 0.13 millimeters, respectively). Suitable compounds for the backing material include polyethylene and polypropylene, other materials known to have similar materials properties for this application may be used.

This lenticular insert may be used to manufacture an integral injection molded lenticular cup as more specifically described in one or more of: the commonly owned applications cited above; U.S. Pat. No. 6,490,063; Published US Patent Application US 2002/0114080; and the following International Applications Published under the Patent Cooperation Treaty: WO 01/96079A2 and 02/051611A1. As specified in those documents, typical substrates (i.e., the injected molded plastic into which the lenticular insert is integrally formed) include plastics such as polyethylene, polypropylene, PVC or a blend using one of these plastics with other materials.

Specifically, the lenticular sleeves of this invention may be used to manufacture lenticular cups as described in the documents noted above by being components of the following processes:

(1) Providing a lenticular lens material sheet comprising a lenticular lens layer having a first and a second surface and an ink layer bonded to the second surface of the lenticular lens layer, bonding a substrate to the ink layer; cutting a lenticular piece from the lenticular material sheet; forming a lenticular insert in the configuration of a sleeve; positioning the lenticular insert in a mold cavity of a plastic molding assembly; operating the plastic molding assembly to process a plastic material charge into the mold cavity at a predetermined molding temperature and to form the plastic object; and cooling and ejecting the plastic product from the mold cavity; in which at least a portion of the substrate bonds to the plastic material charge during the operating of the plastic molding assembly and in which the substrate is adapted for thermally isolating the ink layer during the operating of the plastic molding assembly.

(2) Providing a thin lenticular insert in the form of a closed-surface sleeve comprising a lenticular lens layer having a first and a second surface and an ink layer bonded to the second surface of the lenticular lens layer; providing a mold cavity of a plastic molding assembly configured to define the dimensions of the plastic product; positioning the lenticular insert in the mold cavity with the first surface adjacent a wall of the mold cavity; operating the plastic molding assembly to at least partially fill the mold cavity with liquid plastic, in which the mold cavity and lenticular insert being configured such that a frame member is formed along each exposed edge of the lenticular insert; cooling the mold cavity, and ejecting the hardened plastic product with the lenticular insert retained in position by the frame members.

It should be noted that this process is less preferred to the extent that a frame member is formed, because the design of the lenticular sleeve of the invention generally makes frame members unnecessary.

(3) Providing a closed-surface lenticular insert comprising a lenticular lens layer having a first and a second surface, an ink layer bonded to the second surface of the lenticular lens layer, and a substrate bonded to the ink layer; positioning the lenticular insert in a mold cavity of a plastic molding assembly, and operating the plastic molding assembly to process a plastic material charge into the mold cavity at a predetermined molding temperature and to form the plastic object; in which at least a portion of the substrate bonds to the plastic material charge during the operating of the plastic molding assembly and in which the substrate is adapted for thermally isolating the ink layer during the operating of the plastic molding assembly.

(4) Providing a thin lenticular insert in the form of a closed-surface sleeve comprising a lenticular lens layer having a first and a second surface and an ink layer bonded to the second surface of the lenticular lens layer, providing a mold cavity of a plastic molding assembly configured to define the dimensions of the plastic product; positioning the lenticular insert in the mold cavity with the first surface adjacent a wall of the mold cavity; operating the plastic molding assembly to at least partially fill the mold cavity with liquid plastic, in which the mold cavity and lenticular insert being configured such that a frame member is formed along each exposed edge of the lenticular insert, the lenticular insert being retained in position by the frame members.

Again, this process is less preferred to the extent that a frame member is formed, because the design of the lenticular sleeve of the invention generally makes frame members unnecessary.

To manufacture lenticular sleeve of this example, the first step is to print the smooth lower side of the extruded lenticular lens material. The lenticular lens sheet size can range in size from ten by fourteen inches (25.4 by 35.6 centimeter) to twenty-eight by forty inches (71.1 by 101.6 centimeter), depending on the images, colors, and other aspects of the image desired. Depending on sheet size, and the tapered cup blank size desired, the locations of multiple blanks can be arranged together in the plane of the lenticular sheet and therefore printed on a single sheet at the same time. The inks may be 4-color process or any combination of desired colors commercially available, inks can either be conventional or UV cured. The printing method could be, but is not limited to, a lithographic press configured with UV Lamps to cure the ink. Web printing is also suitable.

The optional backing layer may be used for one of more of the following purposes: to add thickness; to add opacity; to provide a cushion so the ink of the image layer is not distorted from the temperature or pressure imposed by the injected plastic; or to serve as a bonding layer to promote greater adhesion to the plastic used in the injection molding process. There are many suitable methods for adding the optional backing layer, including: thermal lamination; use of a coating machine such of the well-known Billhoffer type; extrusion coating; coating a laminate material; and printing a coating material in place. If web printing is used, the lamination can be performed inline.

The next steps are to cut (e.g., diecut, male-female punch, or any other suitable technique) the tapered cup blanks from the lenticular sheets, followed by conversion of the lenticular tapered cup blanks into lenticular tapered sleeves on modified paper cup making equipment. If web printing is used, inline rotary diecutting is acceptable.

Suitable paper cup equipment includes the model PMC OW800 overwrapping machine manufactured by Paper Machinery Corporation (Milwaukee, USA). Other suitable machines include the PMC 1002 cup forming machine manufactured by the same company. In general, the machine takes blanks, starts them around a mandrel, then transfers the assembly to another station which blows hot air on the two sealed surfaces (one from top and one from bottom) at approximately 700 Celsius (1300 degrees Fahrenheit). The machine then folds the blanks around the mandrel and a pressure foot comes down and holds the two ends against each other for a very short time until the two surfaces are bonded to each other. This type of machine can be modified to use other methods of bonding such as adhesive or chemical bonding if desired.

Finally, an optional step is to nest and stack finished sleeves for bulk packaging or transport to the injection molding apparatus, at which the lenticular tapered sleeves are then inserted into injection molds. Suitable equipment for this purpose is disclosed in U.S. Pat. No. 6,267,550, the entire contents of which are incorporated by reference.

In one embodiment, due to the taper of the lenticular sleeve and the taper of the die in the injection molding apparatus, the sleeve will only enter the die until the outer surface of the tapered sleeve equals the inner tapered surface of the female portion of the die. In some embodiments, various means for holding the lenticular sleeve in place may be used, such as the known pin system, friction, vacuum or electrostatic forces. All of these hold the lenticular sleeve against the inner diameter of the mold so that the molded cup may be formed properly to the inside of the inner side of the lenticular sleeve. In any case, the molten injection-molded plastic will tend to additionally hold the sleeve in place as it flows to form the cup. In one embodiment, the molten plastic also forms a lip below and above the sleeve to prevent the sleeve from sliding down the taper of the cup.

In this embodiment, it is preferred that the ink layer be backed by an opaque layer to enhance the optical properties of the image layer, and further that the backing layer be a bonding layer to enhance the bond between the sleeve and the injection molded plastic despite the heat generated from the plastic; the backing layer also provides a cushion to help prevent distortion of the ink layer, which could adversely affect the lenticular image or animation created by the ink layer and lenticular material.

### EXAMPLE TWO

A tapered lenticular sleeve that can be attached to existing paper or plastic cups is constructed generally as described in Example One. Once the tapered cup blanks have been cut or punched from the lenticular sheets, they are converted into lenticular tapered sleeves on the modified paper cup making equipment; again, the model PMC OW800 overwrapping machine manufactured by Paper Machinery Corporation (Milwaukee, USA) is suitable as described above. Other suitable machines include the PMC 1002 cup forming machine manufactured by the same company. Heat and pressure are satisfactory but adhesives or chemical bonding techniques can also be used. The sleeves may be nested and stacked for packaging, if desired.

Variations on this embodiment include: (1) omission of optional backing layer 40; and (2) use of a thermal insulation layer as optional protection layer 50 so that the lenticular sleeve is suitable for non-insulated containers holding hot or cold contents, such as a paper cup holding hot coffee.

Lenticular sleeves formed in this manner may be slid onto existing paper or plastic cups. It is possible for tapered plastic injection molded cups to be manufactured with features that provide a built in locking mechanism, such that when the sleeve is slid over the locking mechanism, the mechanism engages and holds the sleeve from sliding back down the taper. Alternatively, the sleeve could be printed with a tacky non-skid coating to adhere the sleeve to the existing cup surface.

It is possible to design a mechanical feature, such as a lip, into any object that such a lenticular sleeve slides upon, to hold the lenticular sleeve in position on the object. Such a feature could be incorporated into the mold of either an injection molding or a blow molding process, or as known in the art for other processes of forming containers or objects.

### EXAMPLE THREE

The lenticular blanks of Example Two may be formed as described above, but instead of being formed into free-standing sleeves, they may be attached to preexisting paper or plastic cups or containers. The preferred attachment technique is the use of any form of suitable adhesive, either a separately applied material or a layer or coating of adhesive added to the integral laminate.

The model OW800 wrapping machine manufactured by Paper Machine Corporation is suitable. Other suitable machines include the PMC 1002 cup forming machine manufactured by the same company. The machine takes the lenticular blanks and applies adhesive to at least one edge, then places a cup or container onto a mandrel. The blanks are affixed around the cup or container, preferably by using clamps to hold the lenticular sleeve against the cup or container for the period of time required for the overlapping sleeve to be bonded to the cup (e.g., by activating the layer or coating of adhesive). One preferred type of adhesive is a hot melt moisture cure urethane, although the exact selection would depend on various parameters such as throughput desired, temperature required for activation, and so on.

The adhesive bonds the lenticular laminate to the surface of the cup or container at least along vicinity of the seam edge. In other embodiments, the equipment could be modified to bond the wrap to the entire surface of the cup or container, or any variation of glue pattern created on the lenticular blank.

As before, it is desirable to nest and stack the finished cups or containers for subsequent packaging, but this is not critical to the scope of the invention.

### EXAMPLE FOUR

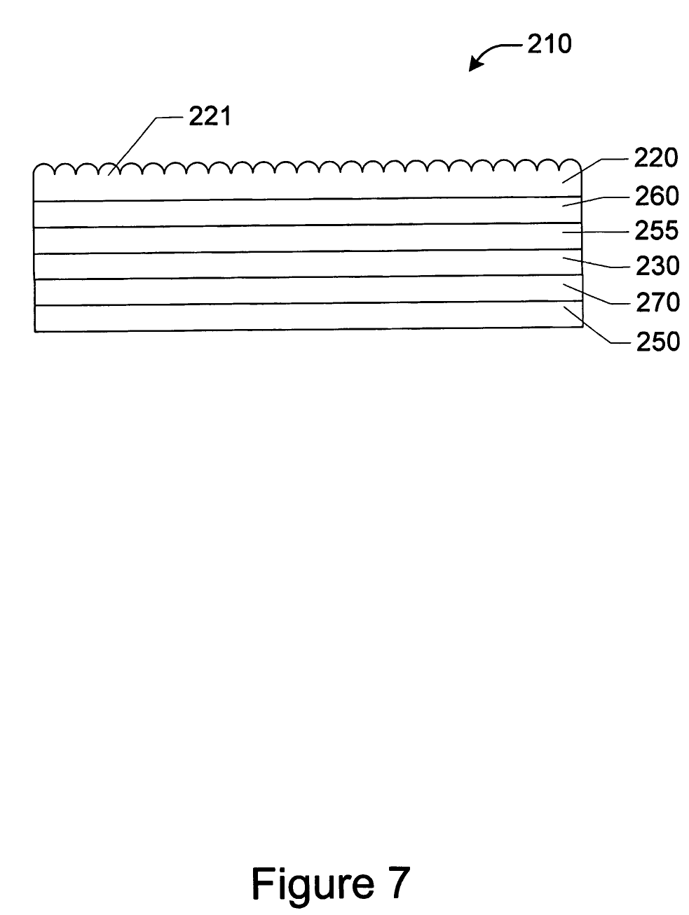

A tapered lenticular cup may be manufactured as generally described above, but as illustrated in FIG. 7, a different construction is employed in the integral laminate that forms the lenticular blank. Specifically, lenticular blank 210 comprises six layers. Proceeding from the outer (in the Figure, the upper) side to the inner (lower) side, they are embossing lens layer 220, in which lenticules 221 are formed as described below; clear core layer 260; outer bonding layer 255; ink layer 230; paper core layer 270; and inner bonding layer 250. The entire lenticular blank 210 has thickness between 0.015 inches and 0.020 inches (0.38 and 0.51 millimeters). Preferred materials and other parameters for each layer follow.

Embossing Lens Layer

Polypropylene or polyethylene; approximate thickness 0.005 to 0.009 inches (0.13 to 0.23 millimeters)

Clear Core

Polyethylene or polypropylene; approximate thickness 0.005 to 0.009 inches (0.13 to 0.23 millimeters)

Outer Bonding Layer

Polyethylene or polypropylene; approximate thickness 0.0025 to 0.001 inches (0.0064 to 0.025 millimeters)

Ink

UV or conventional

Paper Core

White paper board, approximately 0.009 inches (0.229 millimeters) in thickness. Other materials may be substituted for paper board in accordance with known principles, thus the term “paper” should be appreciated as a term of identification and not of composition.

Inner Bonding Layer

Polyethylene or polypropylene; approximate thickness 0.0025 to 0.001 inches (0.064 to 0.025 millimeters)

To manufacture this embodiment, the first step is to print one side of the paperboard layer. The lenticular lens sheet size can range in size from ten by fourteen inches (25.4 by 35.6 centimeter) to twenty-eight by forty inches (71.1 by 101.6 centimeter), depending on the images, colors, and other aspects of the image desired. If web production is used, the roll of material has a width determined by the web handling equipment employed and other considerations within the skill of the art.

Depending on sheet size, and the tapered cup blank size desired, the locations of multiple blanks can be nested together in the plane of the lenticular sheet and therefore printed on a single sheet at the same time. The inks may be 4-color process or any combination of desired colors commercially available, inks can either be conventional or UV cured. The printing method could be, but is not limited to, a lithographic press configured with UV Lamps to cure the ink.

Next, an extrusion coating of polyethylene or polypropylene is applied to the outer and inner sides of the paper sheets. Either clear polypropylene or polyethylene is then applied to form the clear core layer. Suitable techniques include cold, thermal, or belt laminating. The embossing lens layer is next applied by extrusion coating, cold laminating or thermal laminating. The final step to form the laminate is to emboss the lenticular surface into the embossing layer to form the lenticular pattern. In the preferred embodiment, this step can be performed inline while applying the embossing layer. Care must be taken to register the lenticular pattern parallel to the ink printed on the paperboard, but this is within the skill of the art. As with the other examples, the blanks are removed from the sheet by diecutting, male-female punch, and the like.

To convert the lenticular tapered cup blanks into lenticular cups, modified or existing paper cup making equipment as described above may be used. Again, a suitable apparatus is the model OW800 manufactured by Paper Machine Corporation. Other suitable machines include the PMC 1002 cup forming machine manufactured by the same company. The machine takes blanks, and pre made paper bottom pieces, and makes cups in the same fashion conventional paper cups are made. Further details are contained in U.S. Pat. Nos. 5,569,143 and 5,624,367, the entire contents of which are incorporated by reference. The optional step of nesting and stacking the finished cups for packaging, as described above, is preferred but not required by the invention.

In the above description and the claims, “closed-surface” means that two opposed edges of the lenticular material or blank have been brought together and joined to each other by an edge-to-edge or “butt” joint, an angle or skived joint, an overlapping joint, a lap seam, and so on. This forms a hollow sleeve of lenticular material prior to any attachment of the sleeve to another object. The edge-to-edge scam may be any pattern, including straight, sinusoidal, zig-zag, and so on. “Electric potential” includes both electrostatic charge and dynamically controlled electromagnetic forces. “Integral” refers to a condition in which (intended or unintended) removal or disassembly would significantly impair the function of an assembly or laminate, or significantly reduce the commercial or technical quality of the same when the intended purpose of the product is considered.

It should be understood that laminates said to comprise, ie., to include but not be limited to, specific layers can also have additional layers not specified disclosed here if they do not affect the scope of the invention. For example, it is known in the art to use auxiliary opaque ink layers on the back (non-viewed) side of an image layer to enhance the optical performance of the ink used to create the image layer. The invention and the specific examples and disclosure above should be understood as specifying layers that not only are in direct contact with each other, but that also are separated from each other yet functionally adjacent in the sense that the invention nonetheless operates according to the principles disclosed above as they are understood in the art. In the regard, the terms “inner” and “outer” and those of similar import used to describe surfaces or locations of layers should be understood to specify relative locations as appropriate.

Unless specifically identified above as a critical measurement, all numerical values above should be understood to be approximate values that could lie within a range of manufacturing and/or measurement tolerance that does not affect the performance or function of the invention as defined by the claims.

We claim:

1. A method of fabricating plastic products with integral lenticular lens material, comprising:
a) providing a lenticular lens material sheet comprising a lenticular lens layer having a first and a second surface and an ink layer bonded to the second surface of the lenticular lens layer;
b) bonding a substrate to the ink layer,
c) cutting a lenticular piece from the lenticular material sheet;
d) forming a lenticular insert in the configuration of a sleeve;
e) positioning the lenticular insert in a mold cavity of a plastic molding assembly,
f) operating the plastic molding assembly to process a plastic material charge into the mold cavity at a predetermined molding temperature and to form the plastic object; and
g) cooling and ejecting the plastic product from the mold cavity,
h) in which at least a portion of the substrate bonds to the plastic material charge during the operating of the plastic molding assembly and in which the substrate is adapted for thermally isolating the ink layer during the operating of the plastic molding assembly.

2. The method of claim 1, in which the molding temperature in the range of approximately 150 to 375 Celsius.

3. The method of claim 2, in which the plastic material charge is selected from a group of plastics consisting of polypropylene, styrene, polyethylene, and polyvinyl chloride.

4. The method of claim 1, in which the substrate comprises a material selected from a group of materials consisting of polypropylene, polyester, polyvinyl chloride, polycarbonate, APET, UV-curable coatings, solvent-based coatings, E-beam-curable coatings, and water-based coatings.

5. The method of claim 1, in which the substrate has a thickness selected from the range of 0.0127 to 0.0762 millimeter.

6. The method of claim 1, the method further including, prior to the bonding of the substrate, fabricating the substrate by providing a release liner and applying a substrate material to the release liner and in which the bonding of the substrate comprises forcing the ink layer and the substrate material into contact, activating the substrate material with heat and pressure to attach the substrate material to the ink layer, and removing the release liner.

7. The method of claim 1, in which the substrate comprises a coating material and the bonding of the substrate comprises coating the ink layer with the coating material.

8. The method of claim 1, in which the plastic molding assembly is an injection molding machine or a blow molding machine.

9. The method of claim 1, further including concurrently with the operating of the plastic molding assembly, retaining the first surface of the lenticular insert in contact with an outer wall of the mold cavity to block flow of the plastic material charge onto the first surface.

10. The method of claim 9, in which the retaining of the first surface comprises developing a vacuum and applying the vacuum to a portion of the first surface.

11. The method of claim 9, in which the retaining of the first surface comprises developing an electric potential between the outer wall of the mold cavity and a portion of the first surface.

12. The method of claim 9, in which the retaining of the first surface includes attaching raised surface members to an exposed side of the substrate, the raised surface members contacting a center die element in the mold cavity of the plastic molding assembly during the positioning of the lenticular insert.

13. A plastic product fabricated according to the method of claim 1.

14. A method for manufacturing a plastic product with lenticular lens material, comprising:
a) providing a thin lenticular insert in the form of a closed-surface sleeve comprising a lenticular lens layer having a first and a second surface and an ink layer bonded to the second surface of the lenticular lens layer,
b) providing a mold cavity of a plastic molding assembly configured to define the dimensions of the plastic product;
c) positioning the lenticular insert in the mold cavity with the first surface adjacent a wall of the mold cavity;
d) operating the plastic molding assembly to at least partially fill the mold cavity with liquid plastic, in which the mold cavity and lenticular insert being configured such that a frame member is formed along each exposed edge of the lenticular insert;
e) cooling the mold cavity, and
f) ejecting the hardened plastic product with the lenticular insert retained in position by the frame members.

15. The method of claim 14, in which the predetermined distance is less than about 0.06 inches.

16. The method of claim 14, further including, prior to the positioning of the lenticular insert, bonding a substrate to the ink layer, the substrate having a thickness and thermal resistance that in combination prevent the ink layer from damage during the operating of the plastic molding assembly.

17. The method of claim 14, in which at least one frame member extends a predetermined distance onto the first surface.

18. The method of claim 17, further including, prior to the positioning of the lenticular insert, forming a beveled edge on the exposed edges of the lenticular insert to provide a flow passage for the liquid plastic in the operating step and to define the predetermined distance.

19. A product for displaying images created with lenticular lens material, comprising:
a) a plastic display surface;
b) a closed-surface lenticular sleeve positioned in abutting contact with the display surface, the lenticular insert including a lenticular lens layer having a first and a second surface, an ink layer bonded to the second surface of the lenticular lens layer, and a bonding and thermal protection substrate attached to and covering the ink layer; and
c) means for retaining the lenticular insert in the abutting contact position on the display surface.

20. The product of claim 19, in which the retaining means comprises a bonding interface between the substrate and material of the plastic display surface.

21. The product of claim 20, in which the substrate comprises a material selected from a group of materials consisting of polypropylene, polyester, polyvinyl chloride, polycarbonate, APET, UV-curable coatings, solvent-based coatings, E-beam-curable coatings, and water-based coatings.

22. The product of claim 21, in which the substrate has a thickness selected from the range of 0.0127 to 0.0762 millimeter.

23. The product of claim 19, in which the retaining means comprises frame members connected to the display surface and abuttingly contacting exposed edges of the lenticular insert.

24. The product of claim 23, in which the frame members extend a predetermined retention distance onto the first surface adjacent each of the exposed edges.

25. The product of claim 19, in which the product is a container and the display surface is an outer wall of the container.

26. The product of claim 25, in which the lenticular insert extends along substantially the entire perimeter of the outer wall such that two side edges of the lenticular insert form a seam.

27. A method of fabricating plastic products with integral lenticular lens material, comprising:
a) providing a closed-surface lenticular insert comprising a lenticular lens layer having a first and a second surface, an ink layer bonded to the second surface of the lenticular lens layer, and a substrate bonded to the ink layer-,
b) positioning the lenticular insert in a mold cavity of a plastic molding assembly; and
c) operating the plastic molding assembly to process a plastic material charge into the mold cavity at a predetermined molding temperature and to form the plastic object
in which at least a portion of the substrate bonds to the plastic material charge during the operating of the plastic molding assembly and in which the substrate is adapted for thermally isolating the ink layer during the operating of the plastic molding assembly.

28. The method of claim 27, further comprising cooling and ejecting the plastic product from the mold cavity.

29. The method of claim 27, in which the molding temperature in the range of 150 to 375 Celsius.

30. The method of claim 29, in which the plastic material charge is selected from a group of plastics consisting of polypropylene, styrene, polyethylene, and polyvinyl chloride.

31. The method of claim 27, in which the substrate comprises a material selected from a group of materials consisting of polypropylene, polyester, polyvinyl chloride, polycarbonate, APET, UV-curable coatings, solvent-based coatings, E-beam-curable coatings, and water-based coatings.

32. The method of claim 27, in which the substrate has a thickness selected from the range of 0.0127 to 0.0762 millimeter.

33. The method of claim 27, the method further including, prior to the bonding of the substrate, fabricating the substrate by providing a release liner and applying a substrate material to the release liner and in which the bonding of the substrate comprises forcing the ink layer and the substrate material into contact, activating the substrate material with heat and pressure to attach the substrate material to the ink layer, and removing the release liner.

34. The method of claim 27, in which the substrate comprises a coating material and the bonding of the substrate comprises coating the ink layer with the coating material.

35. The method of claim 27, in which the plastic molding assembly is an injection molding machine or a blow molding machine.

36. The method of claim 27, further including concurrently with the operating of the plastic molding assembly, retaining the first surface of the lenticular insert in contact with an outer wall of the mold cavity to block flow of the plastic material charge onto the first surface.

37. The method of claim 36, in which the retaining of the first surface comprises developing a vacuum and applying the vacuum to a portion of the first surface.

38. The method of claim 36, in which the retaining of the first surface comprises developing an electric potential between the outer wall of the mold cavity and a portion of the first surface.

39. The method of claim 36, in which the retaining of the first surface includes attaching raised surface members to an exposed side of the substrate, the raised surface members contacting a center die element in the mold cavity of the plastic molding assembly during the positioning of the lenticular insert.

40. A plastic product fabricated according to the method of claim 27.

41. A method for manufacturing a plastic product with lenticular lens material, comprising:
a) providing a thin lenticular insert in the form of a closed-surface sleeve comprising a lenticular lens layer having a first and a second surface and an ink layer bonded to the second surface of the lenticular lens layer;
b) providing a mold cavity of a plastic molding assembly configured to define the dimensions of the plastic product;
c) positioning the lenticular insert in the mold cavity with the first surface adjacent a wall of the mold cavity;
d) operating the plastic molding assembly to at least partially fill the mold cavity with liquid plastic, in which the mold cavity and lenticular insert being configured such that a frame member is formed along each exposed edge of the lenticular insert, the lenticular insert being retained in position by the frame members.

42. The method of claim 41, further comprising cooling the mold cavity.

43. The method of claim 41, in which at least one frame member extends a predetermined distance onto the first surface.

44. The method of claim 43, in which the predetermined distance is less than about 0.06 inches.

45. The method of claim 41, further including, prior to the positioning of the lenticular insert, bonding a substrate to the ink layer, the substrate having a thickness and thermal resistance that in combination prevent the ink layer from damage during the operating of the plastic molding assembly.

46. The method of claim 41, further including, prior to the positioning of the lenticular insert, forming a beveled edge on the exposed edges of the lenticular insert to provide a flow passage for the liquid plastic in the operating step and to define the predetermined distance.

47. A product for displaying images created with lenticular lens material, comprising:
a) a plastic display surface;
b) a closed-surface lenticular sleeve positioned and integrally retained to the plastic display surface, the lenticular insert including a lenticular lens layer having a first and a second surface, an ink layer bonded to the second surface of the lenticular lens layer, and a bonding and thermal protection substrate attached to the ink layer.

48. The product of claim 47, in which the lenticular sleeve is integrally retained to the display surface by a bonding interface between the substrate and the plastic display surface.

49. The product of claim 47, in which the substrate comprises a material selected from a group of materials consisting of polypropylene, polyester, polyvinyl chloride, polycarbonate, APET, V-curable coatings, solvent-based coatings, E-beam-curable coatings, and water-based coatings.

50. The product of claim 47, in which the substrate has a thickness selected from the range of 0.0127 to 0.0762 millimeter.

51. The product of claim 47, in which the lenticular sleeve is integrally retained to the display surface by members connected to the display surface and abuttingly contacting exposed edges of the lenticular insert.

52. The product of claim 51, in which the frame members extend a predetermined retention distance onto the first surface adjacent each of the exposed edges.

53. The product of claim 47, in which the product is a container and the display surface is an outer wall of the container.

54. The product of claim 47, in which the two side edges of the lenticular insert form a straight seam.

55. The product of claim 47, in which the two side edges of the lenticular insert form a sinusoidal seam.

56. The product of claim 47, in which the two side edges of the lenticular insert form a zig-zag seam.

57. A product for displaying images created with lenticular lens material, comprising:
a) a paper display surface;
b) a closed-surface lenticular sleeve maintained in position adjacent the paper display surface, the lenticular insert including a lenticular lens layer having a first and a second surface, an ink layer bonded to the second surface of the lenticular lens layer, and a bonding and thermal protection substrate attached to the ink layer.

58. The product of claim 57, in which the lenticular sleeve is maintained in position adjacent the paper surface by an adhesive between the substrate and the paper display surface.

59. The product of claim 57, in which the substrate comprises a material selected from a group of materials consisting of polypropylene, polyester, polyvinyl chloride, polycarbonate, APET, UV-curable coatings, solvent-based coatings, E-beam-curable coatings, and water-based coatings.

60. The product of claim 57, in which the substrate has a thickness selected from the range of 0.0127 to 0.0762 millimeter.

61. The product of claim 57, in which the product is a container and the display surface is an outer wall of the container.

62. The product of claim 57, in which the two side edges of the lenticular insert form a straight seam.

63. The product of claim 57, in which the two side edges of the lenticular insert form a sinusoidal seam.

64. The product of claim 57, in which the two side edges of the lenticular insert form a zig-zag seam.

65. A product for displaying images created with lenticular lens material, comprising:
a) a closed surface lenticular sleeve comprising a lenticular lens layer having an lenticular outer surface and a back side, an ink layer bonded to the back side of the lenticular lens layer, and a substrate layer separate from the lenticular lens layer that is attached to and covering a side of the ink layer opposite the back side of the lenticular lens layer;
b) a plastic base layer having a recessed region in which the lenticular sleeve is located so that the lenticular outer surface faces away from the recessed region; and
c) means for holding the lenticular sleeve in the recessed region of the plastic base layer.

66. The product of claim 65, in which the means for holding comprises a bonding interface between a side of the substrate layer not attached to a side of the ink layer and material of the plastic base layer.

67. The product of claim 65, in which the substrate layer comprises a material selected from a group of materials consisting of polypropylene, polyester, polyvinyl chloride, polycarbonate, amorphous polyethylene terephthlate, ultraviolet-curable coatings, solvent-based coatings, electron-beam-curable coatings, and water-based coatings.

68. The product of claim 65, in which the substrate layer has a thickness selected from the range of 0.0127 to 0.0762 millimeter.

69. The product of claim 65, in which the product is a container and at least a portion of the plastic base layer is an outer wall of the container.

70. A plastic product for displaying images created with lenticular lens material, comprising a closed surface lenticular sleeve comprising a lenticular lens layer having an outer surface and a back side, an ink layer bonded to the back side of the lenticular lens layer, and a substrate layer separated from the lenticular lens layer and attached to and covering the ink layer; and a plastic base layer having a recessed region in which the lenticular sleeve is held by an integral bond between the substrate layer and the plastic base layer.

71. A product for displaying images created with lenticular lens material, comprising a closed surface lenticular sleeve comprising a lenticular lens layer having an lenticular outer surface and a back side, an ink layer bonded to the back side of the lenticular lens layer, and a substrate layer separate from the lenticular lens layer that is attached to the ink layer opposite the back side of the lenticular lens layer so as to provide sufficient thermal protection to prevent alteration of the image by a bond between the substrate layer and a plastic base layer having a recessed region in which the lenticular sleeve is located so that the lenticular outer surface faces away from the recessed region.

72. In combination, a plastic material and a closed surface lenticular sleeve for retention in abutting contact by an integral bond with a recessed region formed in the plastic material, the lenticular sleeve comprising a lenticular lens layer having an outer surface and a back side, an ink layer bonded to the back side of the lenticular lens layer, and a substrate layer separated from the lenticular lens layer and attached to and covering the ink layer to prevent thermal alteration of the image by the plastic material.

73. An integrally formed closed-surface lenticular sleeve, comprising
a) an integral laminate having a lenticular layer that has an array of lenticules on an outer face, and
b) an interlaced striped image layer on an inner face of the lenticular layer, the size and number of lenticules being coordinated with the size and number of interlaced stripes forming the image layer.

74. The sleeve of claim 73, in which the integral laminate further comprises a backing layer having an outer side immediately adjacent an inner side of the image layer.

75. The sleeve of claim 74, in which the outer side of the backing layer is in contact with the inner side of the image layer.

76. The sleeve of claim 74, in which the integral laminate further comprises a protection layer having an outer side immediately adjacent an inner side of the backing layer.

77. The sleeve of claim 76, in which the outer side of the protection layer is in contact with the inner side of the backing layer.

78. The sleeve of claim 76, in which the integral laminate is integrally bonded to a substrate immediately adjacent the inner side of the protection layer.

79. The sleeve of claim 78, in which the substrate is thermally molded plastic in contact with the inner side of the protection layer.

80. The sleeve of claim 78, in which the closed surface is formed by mating sides of the integral laminate that are bonded together by a continuous seam.

81. An integrally formed closed-surface lenticular sleeve, comprising:
a) a lenticular layer, comprising an array of lenticules on an outer face of the lenticular layer and having an inner face opposed to the array of lenticules;
b) a clear core layer having an outer face adjacent the inner face of the lenticular layer, and having an opposed inner face;
c) an outer bonding layer having an outer face adjacent the inner face of the clear core layer, and having an opposed inner face;
d) an ink layer having an outer face adjacent the inner face of the outer bonding layer, the ink layer comprising an interlaced striped image, the size and number of the lenticules of the lenticular layer being coordinated with the size and number of interlaced stripes forming the image layer, and the image layer having an inner face;
e) a paper core layer having an outer face adjacent the inner face of the ink layer, and having an opposed outer face; and
f) an inner bonding layer having an outer face adjacent the inner face of the paper core layer.

82. The sleeve of claim 81, in which the closed surface is formed by mating sides of the integral laminate that are bonded together by continuous seam.
